(19) United States
(12) Patent Application Publication
(10) Pub. No.: US 2004/0228516 A1
(43) Pub. Date: Nov. 18, 2004

(54) Defect detection method

(75) Inventors: Gilad Golan, Ra'anana (IL); Oma Bregman-Amitai, Tel Aviv (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(73) Assignee: Tokyo Seimitsu Co (50%) and Accretech (Israel) Ltd (50%)

(21) Appl. No.: 10/435,552

(22) Filed: May 12, 2003

(51) Int. Cl. G06K 9/00

(52) U.S. Cl. 382/147

(57) ABSTRACT

A method for inspecting a repeating pattern of a sample for defects. The repeating pattern has a translation vector, which defines a separation of substantially identical sections of the repeating pattern. The repeating pattern has a first section and a second section which are separated substantially by the translation vector. The method includes comparing the first section and the second section to identify a discrepancy indicative of a possible defect. The method also includes analyzing a reference data source in order to identify if the defect exists, and when the defect exists, in which one of the first section and the second section the defect exists. The reference data source is derived from a source exogenous to the sample.

### FIELD AND BACKGROUND OF THE INVENTION

The present invention relates to a method of detecting defects in a periodic pattern of a sample and, in particular, it concerns a method for inspecting silicon wafers, masks and similar structures used in the Integrated Circuits (IC) industry.

Inspection for defects is usually based on methods of comparison. These methods are divided into two techniques that are known in the art.

The first technique is based on a comparison between a pattern of a region under inspection with a reference pattern that represents an ideal defect-free pattern. The reference pattern is typically CAD data or a “Golden Die”. A “Golden Die” is a die that is known to be substantially defect-free. Die-to-Golden Die comparison is described in the background of U.S. Pat. No. 6,252,412 to Talbot, et al. According to this technique the reference pattern is saved in a memory and then retrieved during the comparison process. In a situation where the area under inspection is big or the inspection requires high resolution or when both criteria are applicable, the memory size needed for storing the reference pattern is very large. In such a case, the memory is too expensive to be used for commercial purposes and the second inspection technique may be used under certain conditions. Patents, such as U.S. Pat. No. 5,978,501 to Badger, et al. have tried to improve conventional die-to-reference comparison methods. Badger, et al. teaches a method and system for detecting defects in the design of a photolithographic mask or a printed wafer. It derives an adaptive inspection algorithm that allows for a tighter inspection of a mask to a data set which has repeatable differences. The inspection is meant to allow flexibility to remove unimportant differences while maintaining a tight inspection capability. U.S. Pat. Nos. 6,091,845 and 6,272,236 to Pierrat, et al., teach an improved technique for inspecting photomasks that employs die-to-reference techniques using simulated images of the resist pattern. A simulated image of an original pattern, the reference, is compared to a simulated image generated from a pattern captured from a photomask manufactured from the original pattern.

The second technique is useful only when the pattern consists of periodic fragments or even periodic structures of sub-fragments at the regions of the basic fragments. In this case, a comparison is made between three fragments or three sub-fragments, which in relation to silicon wafers are known as dies and cells, respectively. Three-fragment comparison is needed to identify the fragment and the defect location within the identified fragment and not just to detect the existence of a defect without the ability to indicate the exact 2) location of the defect. Three-fragment comparison is performed by comparing the fragment under inspection with two adjacent fragments. Statistically, it is assumed that there is a very low probability that a defect will repeat itself at the same position in two other fragments. Therefore, a defect is defined as a deviation that appears twice in the two comparisons and the fragment that contains the defect is the one that differs from the other two fragments. In other words, comparing two fragments can identify that a defect exists in one of the two fragments. Once a defect is identified, both of these two fragments need to be compared to a third fragment to identify in which one of the first two fragments the defect exists. U.S. Pat. Nos. 6,091,845 and 6,272,236 to Pierrat, et al., also teach an improved technique for inspecting photomasks that compares simulated images generated from captured data from two different instances of the same original pattern (die-to-die comparison) formed in a photomask.

The comparison is made between two digital images acquired under the same electrical and optical conditions. In other words the electrical gain, signal to noise ratio, optical magnification and imaging quality are substantially the same. Each image under comparison is constructed from a matrix of pixels. Each pixel is characterized by its location and its gray-level value. Two images under comparison are compared on a pixel by pixel basis or a superpixel by superpixel basis. A superpixel by superpixel comparison is a comparison of pixel groups, for example, comparing an average over nine adjacent pixels to another similar group. In other words, the pixels (or the superpixels) corresponding to the same location in each image are compared. A deviation occurs when the difference in gray-level value between the two pixels under comparison is greater than a predetermined threshold value.

Die-to-die comparison, as stated above, requires a minimum of three dice per wafer or mask. However, when a wafer or mask has only two dice, the conventional die-to-die comparison method cannot be employed. Additionally, the conventional die-to-die comparison method generally involves storing data in relation to the image of one complete die and comparative data between two dice (a byte for each pixel). The storage of the image data of one complete die generally requires large memory capabilities.

By way of introduction, thresholds are needed when comparing an image of a die to another source, whether the other source is an image of another die or a reference such as a golden die, due to the inherent noise of the die images. It can be assumed that the noise of a die image is limited within the range −N₁ to +N₂. Therefore, if we compare an image of a die to a reference, which has no inherent noise, any difference which is outside of the above noise range is defined as a defect. However, if we compare an image of a die to an image of another die, which are both noisy, we need to use a higher threshold. Since the noise of the images of two pixels being compared can be in opposite directions, the threshold is set at N₁ plus N₂ in order to avoid false detection of defects. Therefore, die-to-database comparison methods, although generally requiring more processing resources than die-to-die comparison methods, offer much higher accuracy than die-to-die comparison methods due to the noise factor.

There is therefore a need for a method to inspect wafers or masks having only two dice as well as a more efficient as well as accurate method for inspecting wafers or masks having more than two dice.

### SUMMARY OF THE INVENTION

The present invention is a method of inspecting wafers or masks or similar repetitive structures.

According to the teachings of the present invention there is provided, a method for inspecting a repeating pattern of a sample for defects, the repeating pattern having a translation vector which defines a separation of substantially identical sections of the repeating pattern, the repeating pattern having a first section and a second section which are separated substantially by the translation vector, the method comprising: (a) comparing the first section and the second section to identify a discrepancy indicative of a defect; (b) and analyzing a reference data source in order to identify in which one of the first section and the second section the defect exists, wherein the reference data source is derived from a source exogenous to the sample.

According to a further feature of the present invention, the pattern has only one repetition.

According to a further feature of the present invention, the step of comparing is performed by comparing an image of the first section with an image of the second section.

According to a further feature of the present invention, the step of analyzing is performed by, comparing at least one of, an image of the at least part of the first section and an image of the at least part of the second section with the reference data source.

According to a further feature of the present invention, the step of analyzing is performed by: (a) comparing an image of the at least part of the first section with the reference data source; and (b) comparing an image of the at least part of the second section with the reference data source.

According to a further feature of the present invention, there is also provided the step of deriving the reference data source from a Golden die.

According to a further feature of the present invention, there is also provided the step of deriving the reference data source from CAD data.

A method for inspecting a repeating pattern of a sample for defects, the repeating pattern having a translation vector which defines a separation of substantially identical sections of the repeating pattern, the repeating pattern having a first section and a second section which are separated substantially by the translation vector, the method comprising: (a) comparing the first section and the second section to identify a discrepancy indicative of a possible defect; and (b) analyzing a reference data source in order to: (i) identify if the defect exists; and (ii) identify, when the defect exists, in which one of the first section and the second section the defect exists, wherein the reference data source is derived from a source exogenous to the sample.

According to a further feature of the present invention, the pattern has only one repetition.

According to a further feature of the present invention, the step of comparing is performed by comparing an image of the first section with an image of the second section.

According to a further feature of the present invention, the step of analyzing is performed by: (a) comparing an image of the at least part of the first section with the reference data source; and (b) comparing an image of the at least part of the second section with the reference data source.

According to a further feature of the present invention, there is also provided the step of deriving the reference data source from a Golden die.

According to a further feature of the present invention, there is also provided the step of deriving the reference data source from CAD data.

### BRIEF DESCRIPTION OF THE DRAWINGS

The invention is herein described, by way of example only, with reference to the accompanying drawings, wherein:

FIG. 1 is schematic view of a wafer having only two dice that is constructed and operable in accordance with a preferred embodiment of the invention; and

FIG. 2 is a schematic view of a reference data source for use with the wafer of FIG. 1.

### DESCRIPTION OF THE PREFERRED EMBODIMENTS

The present invention is a method of defect detection in a repeating pattern.

The principles and operation of a method of defect detection in a repeating pattern according to the present invention may be better understood with reference to the drawings and the accompanying description.

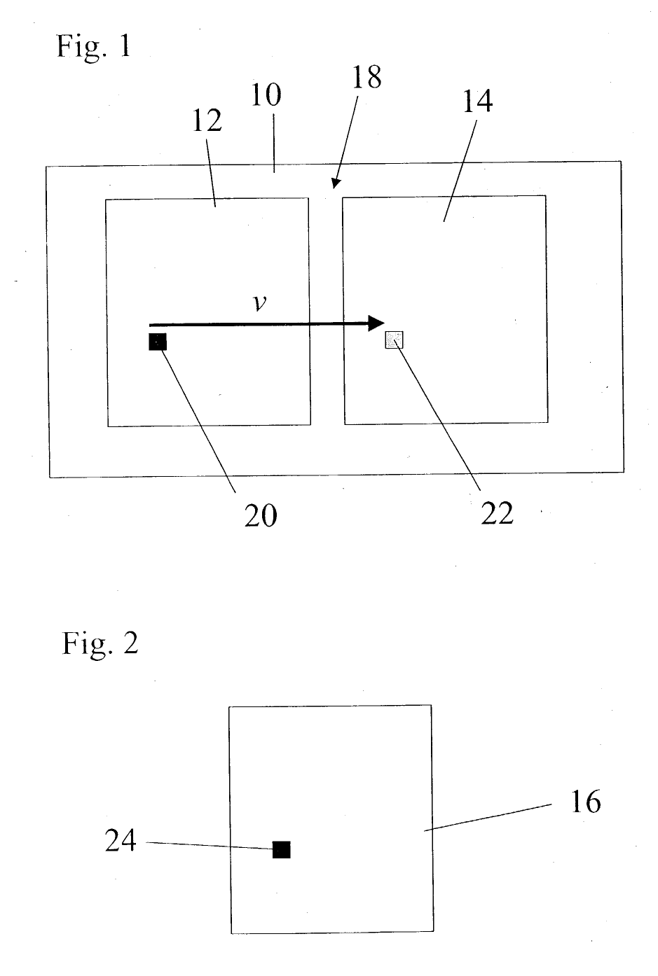

Reference is now made to FIG. 1, which is schematic view of a wafer 10 having only two dice 12, 14 that is constructed and operable in accordance with a preferred embodiment of the invention. Die 12 and die 14 represent a repeating pattern 18 on wafer 10. Wafer 10 only contains these two dice, die 12 and die 14. Therefore, repeating pattern 18 has only one repetition of the pattern. In other words, the pattern of die 12 is only repeated once on wafer 10 as die 14. Repeating pattern 18 has a translation vector v, which defines a separation of substantially identical sections of repeating pattern 18. In other words, translation vector v defines a separation of substantially identical sections of die 12 and die 14. Translation vector v has sub-pixel resolution. The identical sections within repeating pattern 18 are described as “substantially” identical in that the identical sections are the same except for the differences below a predetermined threshold and defects, which are not part of the pattern design. Repeating pattern 18 has a section 20 in die 12 and a section 22 in die 14. Section 20 and section 22 are separated substantially by translation vector v. Section 20 and section 22 are described as being “separated” by translation vector v, in that translation vector v represents the distance between two identical points in each die. Due to inaccuracies of the scanning system an alignment adjustment needs to be made between the images of die 12 and die 14 to ensure that section 20 and section 22 are identified correctly for comparison purposes. Therefore, section 20 and section 22 are described as “substantially” separated by translation vector v, in that section 20 and section 22 are determined after alignment adjustments. Therefore, section 20 and section 22 are separated by an alignment adjusted translation vector v. Additionally, the accuracy of the separation of section 20 and section 22 is typically determined by an operator of the scanning system being used.

The first step in the inspection of wafer 10 is comparing an image of section 20 and an image of section 22 to identify a discrepancy indicative of a defect. A defect is indicated if the gray scale value of the image of section 20 differs from the gray scale value of the image of section 22 by a predetermined limit. Similarly, all the sections of die 12 are compared with all the corresponding sections of die 14 to identify discrepancies indicative of defects. Comparison assumes that substantially same sections of die 12 and die 14 are aligned with sub-pixel accuracy to ensure that the comparison is meaningful. It will be apparent to one ordinarily skilled in the art that section 20 and section 22 may be compared using other methods to identify a discrepancy indicative of a defect such as, comparing characters of images as gradient or morphological characters, changing parameters such as thresholds and by using other methods known in the art.

If a discrepancy is found between section 20 and section 22, then a further step needs to be performed to determine if the discrepancy found is due to a defect in section 20 or a defect in section 22.

Reference is now made to FIG. 2, which is a schematic view of a reference data source 16 for use with wafer 10 of FIG. 1. Reference data source 16 is derived from a source exogenous to the sample under investigation, which is wafer 10 in our example. In accordance with a most preferred embodiment of the present invention, reference data source 16 is derived from CAD data. The CAD data is typically saved in CAD format, such as GDS2 or any other CAD format. The CAD data generally needs to be translated into a gray-scale image in order to compare it directly to an image of a die. It is known in the art how to create an image from CAD data, as is used in die-to-database comparison methods. However, it should be noted that the CAD data could be analyzed using other methods known in the art to identify a defect in a die without having to first convert the CAD data into a gray-scale image.

In accordance with an alternate embodiment of the present invention, reference data source 16 is derived from a Golden Die. It will be apparent to one ordinarily skilled in the art that reference data source 16 may be derived from other sources.

Reference is also made to FIG. 1. In general, reference data source 16 is analyzed to determine whether the defect is in section 20 or in section 22. In accordance with a most preferred embodiment of the present invention, the analysis of reference data source 16 is performed, by performing two comparisons. Firstly, the gray scale value of the image of section 20 is compared with the gray scale value of an image of a corresponding section 24 of reference data source 16. Secondly, the gray scale value of the image of section 22 is compared with the gray scale value of the image of corresponding section 24 of reference data source 16. In this most preferred embodiment the closest match between sections 20, 22 and corresponding section 24 is considered to be the defect-free section. The other section is considered to be the section having the defect. In accordance with an alternate embodiment of the present invention, the analysis of reference data source 16 is performed, by comparing either the gray scale value of the image of section 20 or section 22 with the gray scale value of the image of corresponding section 24 of reference data source 16 in order to identify whether the defect is in section 20 or in section 22. For example, if the gray scale value of the image of section 20 is compared to the gray scale value of the image of corresponding section 24 of reference data source 16 and no discrepancy is found, a discrepancy being defined as a predetermined difference in gray scale value, then it follows that the defect is in section 22. Likewise, if a discrepancy is found then the defect is in section 20 and section 22 is assumed to be defect-free. It should be noted that the comparisons with reference data source 16 can be carried out in real time during the scanning of the dies, or off-line after the scanning process is complete. It will be apparent to one ordinarily skilled in the art that other methods of analysis of reference data source 16 are possible, for example, but not limited to, analyzing the CAD data directly, comparing characters of images as gradient or morphological characters, changing parameters such as thresholds and by using other methods known in the art.

It should be noted, in cases where very few defects are expected, or the reference data files are very large, which is highly relevant to Mask Inspection, it is not generally necessary to have the entire CAD image or other data loaded into memory at one time. Therefore, when a comparison between the CAD or other data and a part of a die is performed, only the corresponding part of the die which is being compared is extracted as an image from the CAD or other data and is loaded into memory, thereby reducing memory requirements. Therefore, the memory size needed is determined by the memory needed to store the data of the images of a section of each die under inspection plus the expected memory needed to store any relevant CAD or other data images.

Additionally, the above method can be adapted to provide a higher degree of accuracy of defect detection than is normally obtained from die-to-die comparison methods. As described above, it can be assumed that the noise of a die image is limited within the range −N₁ to +N₂. Therefore, if we compare an image of a die to a reference, which has no inherent noise, any difference which is outside of the above noise range is defined as a defect. However, if we compare an image of a die to an image of another die, which are both noisy, we need to use a higher threshold. Since the noise of the images of two pixels being compared can be in opposite directions, the threshold is set at N₁ plus N₂ in order to avoid false detection of defects. Therefore, the accuracy of die-to-die comparison methods is less than die-to-database comparison methods.

However, using the method of the present invention, a threshold which is lower than N₁ plus N₂ is used when comparing the image of one die to the image of another die. First, section 20 is compared to section 22 to identify a discrepancy indicative of a possible defect. As the threshold is lower than N₁ plus N₂, many more possible defects are identified at this stage than compared with conventional die-to-die comparison techniques. Second, reference data source 16 is analyzed in order to identify if a defect exists and when a defect exists, in which one of section 20 and section 22 the defect exists. Therefore, even though many false defects may be identified in the first step, false defects are identified by comparison to reference data source 16 in the second step. Additionally, the method of the present invention results in detecting many more real defects that would go undetected in prior art die-to-die comparison methods.

The minimum value of the threshold is limited by the access rate to the reference. If the access rate required is too high, then conventional die-to-database comparison may be more efficient. It should be noted that even using the above method of the present invention with a very low threshold, some small defects could be missed.

Additionally, differences which are identified using die-to-die comparison are not always defects even when a high threshold is used. For example, the user may define defects as a percentage size difference of a feature from a planned size of the feature. When two dice are compared, both the features may differ from the planned size. However, the planned size of the feature is not known from either of the dice. Therefore, die-to-die comparison is not always accurate to detect these sorts of defects. Therefore, the method of the present invention overcomes this difficulty, by comparing possible defects in each die, such as those of the above example, to the reference.

Additionally, the use of a reference enables smarter classification of defects. Conventional die-to-die comparison can be used to identify if and where a defect exists. However, the severity and nature of the defect can only be identified by comparison to a reference.

By way of introduction, in some imaging systems, the expected noise range is a function of the actual gray level. Therefore, the noise range of each section or pixel or super-pixel depends upon the actual gray level of the section, pixel or super-pixel concerned. Therefore, the use of a reference enables adjusting the threshold for each section, pixel or super-pixel according to actual gray level of the reference. Therefore, lower thresholds can be used, resulting in higher detection sensitivity without false detection problems. This cannot be achieved when two sections are compared using die-to-die comparison, as we do not know which of the dice, if any contains the ideal section.

Although the above method has been described with reference to a wafer having two dice, it will be apparent to one ordinarily skilled in the art that the above method can be used to detect defects in a wafer having three or more dies. Additionally, it will be apparent to one ordinarily skilled in the art that the above method can be used in the inspection of lithographic masks and similar structures having repetitive patterns.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art which would occur to persons skilled in the art upon reading the foregoing description. Although the invention has been described using the example of scanning silicon wafers, the invention can be used for many other applications such as inspecting Printed Circuits Boards (PCB), projecting masks or any other surface having periodic pattern.

What is claimed is:

1. A method for inspecting a repeating pattern of a sample for defects, the repeating pattern having a translation vector which defines a separation of substantially identical sections of the repeating pattern, the repeating pattern having a first section and a second section which are separated substantially by the translation vector, the method comprising:
(a) comparing the first section and the second section to identify a discrepancy indicative of a defect; and
(b) analyzing a reference data source in order to identify in which one of the first section and the second section said defect exists, wherein said reference data source is derived from a source exogenous to the sample.

2. The method of claim 1, wherein the pattern has only one repetition.

3. The method of claim 1, wherein said step of comparing is performed by comparing an image of the first section with an image of the second section.

4. The method of claim 1, wherein said step of analyzing is performed by, comparing at least one of, an image of said at least part of the first section and an image of said at least part of the second section with said reference data source.

5. The method of claim 1, wherein said step of analyzing is performed by:
(a) comparing an image of said at least part of the first section with said reference data source; and
(b) comparing an image of said at least part of the second section with said reference data source.

6. The method of claim 1, further comprising the step of deriving said reference data source from a Golden die.

7. The method of claim 1, further comprising the step of deriving said reference data source from CAD data.

8. A method for inspecting a repeating pattern of a sample for defects, the repeating pattern having a translation vector which defines a separation of substantially identical sections of the repeating pattern, the repeating pattern having a first section and a second section which are separated substantially by the translation vector, the method comprising:
(a) comparing the first section and the second section to identify a discrepancy indicative of a possible defect; and
(b) analyzing a reference data source in order to:
(i) identify if said defect exists; and
(ii) identify, when said defect exists, in which one of the first section and the second section said defect exists, wherein said reference data source is derived from a source exogenous to the sample.

9. The method of claim 8, wherein the pattern has only one repetition.

10. The method of claim 8, wherein said step of comparing is performed by comparing an image of the first section with an image of the second section.

11. The method of claim 8, wherein said step of analyzing is performed by:
(a) comparing an image of said at least part of the first section with said reference data source; and
(b) comparing an image of said at least part of the second section with said reference data source.

12. The method of claim 8, further comprising the step of deriving said reference data source from a Golden die.

13. The method of claim 8, further comprising the step of deriving said reference data source from CAD data.
